(19) United States
(12) Patent Application Publication
(10) Pub. No.: US 2015/0137958 A1
(43) Pub. Date: May 21, 2015

(54) WIRELESS REMOTE CONTROL

(71) Applicant: LumenRadio AB, Goteborg (SE)

(72) Inventors: Niclas Bo Norlén, Uddevalla (SE); Michael Karlsson, Kode (SE); Peter David Kirkup, Goteborg (SE)

(73) Assignee: LumenRadio AB, Goteborg (SE)

(21) Appl. No.: 14/548,786

(22) Filed: Nov. 20, 2014

Related U.S. Application Data
(60) Provisional application No. 61/951,265, filed on Mar. 11, 2014.
(60) Provisional application No. 61/907,097, filed on Nov. 21, 2013.

(51) Int. Cl. G08C 17/02

(52) U.S. Cl. CPC G08C 17/02
USPC 340/12.5

(57) ABSTRACT

A system and method a wireless remote control solution is implemented in an integrated circuit (IC) and that IC is specified to the controller manufacturer. The controller manufacturer provides an IC-compatible electromechanical interface in communication with a central processing unit (CPU) of the controller. When the manufacturer is ready to implement a wireless solution, the IC is installed into the IC-compatible electromechanical interface. Different wireless solutions and/or protocols are enabled by the manufacturer's choice of IC that is installed.

### CROSS REFERENCE TO RELATED APPLICATIONS

This application claims benefit of both U.S. Patent Application No. 61/907,097 filed 21 Nov. 2013 and U.S. Patent Application No. 61/951,265 filed 11 Mar. 2014, the contents of which are hereby expressly incorporated by reference thereto in their entireties for all purposes.

### FIELD OF THE INVENTION

The present invention relates generally to wireless digital control, and more specifically, but not exclusively, to wireless digital remote control of lighting and devices.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A United States Institute for Theatre Technology (USITT) standard, USITT DMX512/1990, defines a Digital MultipleX (DMX) standard for digital communications networks used to control stage lighting and effects. An American National Standards Institute (ANSI) standard, “E1.11-2008, USITT DMX512-A” addresses a similar technology referred to as DMX512-A. Both standards are hereby expressly incorporated by reference thereto for all purposes.

As initially implemented, DMX512 included a wired multi-drop bus topology having nodes interconnected in a daisy chain. Each network includes a controller (the master) and one or more slave devices. As the number of devices in any particular network grows, and as a physical expanse of a network increases, the cabling used to implement the network makes implementation and servicing of a network very complex. In some implementations cable lengths may be prohibitively long which makes wired implementations impractical.

The industry has responded by designing and implementing wireless DMX512 adapters in which a wireless transmitter is provided at the controller to communicate with one or more receivers located near and associated with the slave devices. The controller issues standard DMX512 commands, the transmitter encodes the commands and transmits to the receiver which restores the standard DMX512 commands for use by an associated slave device.

Not all wireless protocols used by the wireless DMX512 adapters are compatible, both electrically and physically. Each wireless adapter is typically designed as a stand-alone printed circuit board (PCB) with all necessary hardware, firmware, and software, including connectors. A manufacturer of a controller that desires to implement a wireless solution typically must redesign its product to interconnect and operate with a specific adapter. Should the controller manufacturer desire to change adapter solutions, a more than insignificant redesign of the controller is typically required to accommodate the new adapter electrical, connector, and form factor requirements. This situation slows adoption and acceptance of wireless solutions. Sometimes redesign and testing is required when the adapter is revised to incorporate new features or technologies.

Another impediment to adoption and implementation of DMX512 wireless solutions can be that the controller is specified at an operational and functional level that includes limited resources that are barely capable, if at all, of implementing a DMX standard. Thus the manufacturer is prohibited or inhibited from implementing a DMX512 wireless solution even for those cases when it is desired to provide such a solution.

CRMX is an acronym for Cognitive Radio Multiplexer. It is an automated and adaptive wireless technology specifically developed for the lighting and related industries. CRMX wireless transmissions never disturb, or are disturbed by, other wireless equipment. This fully automated feature offers unrivaled convenience and peace of mind during operation. CRMX is further described in U.S. Pat. No. 8,457,023 issued 4 Jun. 2013 and is hereby expressly incorporated by reference thereto in its entirety for all purposes.

What is needed is a system and method for overcoming limitations of the conventional solutions and providing for improvements that facilitate adoption, implementation, and use of wireless solutions.

### BRIEF SUMMARY OF THE INVENTION

Disclosed is a system and method for overcoming limitations of the conventional solutions and providing for improvements that facilitate adoption, implementation, and use of wireless solutions.

The following summary of the invention is provided to facilitate an understanding of some of technical features related to wireless digital remote control of lighting and devices using a DMX512 standard, and is not intended to be a full description of the present invention. A full appreciation of the various aspects of the invention can be gained by taking the entire specification, claims, drawings, and abstract as a whole. The present invention is applicable to other wireless remote control standards, including, for example, System Information Packets (SIP), Remote Device Management (RDM), Architecture for Control Networks (ACN), digital addressable lighting interface (DALI), Art-Net, and the like.

In one implementation, the wireless solution is implemented in a discrete integrated circuit (DIC) or assembly such as a microchip, a microcontroller, a package-on-package system, a programmable device package, an Application Specific Integrated Circuit (ASIC) and/or a System on a Chip (SOC), or the like that may include one or more of a microcontroller/microprocessor/digital signal processor, memory, timing sources, peripherals, timers, digital and analog input/output interfaces (including for example serial peripheral interface (SPI) and the like, and voltage regulators and power management circuits that DIC is specified to the controller manufacturer. The controller manufacturer provides a DIC-compatible electromechanical interface (e.g., a socket, surface mount, through hole architecture or other support system providing electronic and mechanical communication and compatibility between the DIC and the solution interoperating with the DIC) in communication with a central processing unit (CPU) of the controller. When the manufacturer is ready to implement a wireless solution, the DIC is installed into the DIC-compatible electromechanical interface. Different wireless solutions and/or protocols are enabled by the manufacturer's choice of DIC that is installed. Some implementations may include an end-user upgradeable solution, which will exclude certain types of electromechanical interfaces that do not permit a user to simply and easily exchange one DIC for another. In such a case some type of socket solution may be preferred over a soldered solution. Some implementations may focus on reducing costs, in which reducing component counts and improving manufacturability—in which case a manufacturer may prefer to solder the DIC in place to eliminate the socket.

In another implementation, electrical and signal interfaces to the DIC-compatible electromechanical interface are specified as a standard allowing different adapter vendors to each manufacture a version of their solution into a DIC. The manufacturer is enabled to switch one DIC from one vendor for a DIC of another vendor without significant redesign of its controller to achieve the desired benefits of the new DIC and its particular control architecture.

In still another implementation, a vendor's wireless solution, whether implemented as a DIC, may provide some resource off-loading allowing the wireless adapter implementation to boost the performance of the controller. This would enable the manufacturer of the controller to implement a robust wireless solution without necessarily increasing the manufacturer-provided processing resources of its controller. For example, in some instances a controller is interested in narrow range of channels from the possible DMX channel set. The wireless adapter could provide a filtering function to isolate the desired channels and provide the controller with a reduced set of data for processing. The controller in this sense is in reference to a host processor that offloads some of the processing to the IC.

A fixture is controlled by streaming DMX data to it, a DMX frame is 512 bytes excluding a start byte. Those 512 bytes are repeatedly transmitted to the fixture. The fixture is set to filter out at least one DMX byte which contains relevant data for that fixture. It is not unusual that in the majority of the data frames does not contain any new data but the fixture still needs to filter out the data bytes. For low cost fixtures with constrained resources this is a waste. Some embodiments of the present invention have an option to do the filtering for the fixture and only transmit the relevant data upon change in values using a data interface (e.g., SPI or UART). The interface will alert the fixture-CPU when new data is available and the fixture may then load data whenever resources are available.

An assembly responsive to a set of digital wireless control signals, including a control fixture including a fixture processor and a fixture memory, the control fixture configured to implement a control architecture that produces a set of digital control signals compliant with the control architecture derived from a set of digital control inputs, the fixture processor executing a first set of program instructions accessed from the fixture memory to implement the control architecture; an antenna, coupled to the control fixture, receiving wirelessly the set of digital wireless control signals; and a discrete integrated circuit (DIC), electrically communicated to the fixture processor and to the antenna, configured to implement a wireless control architecture responsive to the set of digital wireless control signals and produce the set of digital control inputs for the control fixture, the wireless control architecture different from the control architecture.

A method for a digital wireless control of a slave device from a master controller, the master controller communicating wirelessly a set of digital wireless control signals and the slave device including a control fixture including a fixture processor and a fixture memory, the control fixture implementing a control architecture that produces a set of digital control signals compliant with the control architecture derived from a set of digital control inputs, the fixture processor executing a first set of program instructions accessed from the fixture memory to implement the control architecture, the method including (a) communicating wirelessly the set of digital wireless control signals to a first discrete integrated circuit (DIC), the first DIC communicated electrically to the fixture processor and configured to implement a first wireless control architecture responsive to the set of digital wireless control signals; and (b) producing the set of digital control inputs for the control fixture derived from the digital wireless control signals, the first wireless control architecture different from the control architecture.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

An example of a DIC is a CRMXchip offered by LumenRadio AB, Applicant of the present application, the CRMXchip being a future of wireless DMX distribution—a wireless system that communicates reliably with enhanced fidelity as compared to existing systems. CRMX is a powerful wireless lighting control system and includes many features to ensure superior reliability. CRMX distributes DMX and RDM, with full frame integrity and provides range and reliability that surpass other systems available today. Included herein is a description of function and specifications of an embodiment of an integrated circuit for a CRMXchip 24DMX512 receiver IC. Features of a CRMX on chip receiver include:

### Supports ANSI E1.11-DMX512-A;

Cognitive coexistence—dynamically avoids occupied frequencies;
DMX fidelity and frame integrity;
DMX frame rate and frame size auto sensing;
Fixed 5 ms end-to-end latency;
Automatic compatibility mode with other protocols, including open, standard, and/or proprietary protocols;
Small footprint (QFN48) 6 mm×6 mm;
Few external components are needed;
All configuration data is stored in on-chip non-volatile memory, 20 years data retention;
CRMXchip contains upgradeable drivers for future proofing; and
Over-the-air driver upgrades.

The CRMXchip 24DMX512 receiver is a highly integrated wireless DMX receiver IC and is compatible with all LumenRadio CRMX transmitters as well as other transmitters implementing other open, standard, and/or proprietary protocols.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a wireless digital control system including a DMX fixture incorporating a wireless IC;

FIG. 2 illustrates details of the DMX fixture;

FIG. 3 illustrates a filtering function decision process;

FIG. 4 illustrates details of the DMX filtering function and representative relevant channels;

FIG. 5 illustrates a representative pin assignment and functions for an implementation of an IC.

FIG. 6 illustrates an example of an SPI transaction;

FIG. 7 illustrates an example SPI command sequence with a pending IRQ when sequence started;

FIG. 8 illustrates a progression in development of wireless DMX control systems;

FIG. 9 illustrates an implementation of a wireless DMX control system of the present invention;

FIG. 10 illustrates a process for using a DMX window of the present invention; and

FIG. 11 illustrates an implementation of a wireless digital control system including a master controller communicating wirelessly to one or more slave devices using a control architecture.

### DETAILED DESCRIPTION OF THE INVENTION

Embodiments of the present invention provide a system and method for overcoming limitations of the conventional solutions and providing for improvements that facilitate adoption, implementation, and use of wireless solutions. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “control architecture” means a control paradigm conforming to a standard for digital communication for controlling lighting (e.g., stage or building automation) and effects using a master controller digitally communicating with one or more slave devices. The digital communications conforms to a ESTA/ANSI/PLASA implemented or draft standard, such as, for example, Entertainment Technology—USITT DMX512-A—Asynchronous Serial Digital Data Transmission Standard for Controlling Lighting Equipment and Accessories, E1.11-2004, USITT DMX512-A, E1.11-2008, USITT DMX512-A, and enhancements thereto such as Remote Device Management (RDM) permitting two-way communications (ANSI E1.20, Remote Device Management Over DMX512 Networks), Architecture for Control Networks (ACN) for control of entertainment technology equipment, for example, lighting, audio or special effects equipment, maintained by PLASA ANSI Standard E1.17-2006-Entertainment Technology —Architecture for Control Networks (and revised and released as ANSI E1.17-2010), Art-Net as a protocol for transmitting the lighting control protocol DMX512-A (with RDM) over the User Datagram Protocol of the Internet Protocol suite, Digital Addressable, Lighting Interface (DALI) including technical standards IEC 60929 and IEC 62386 (International Electrotechnical Commission) for network-based systems that control lighting in building automation, System Information Packet (SIP) added by E1.11-2004, USITT DMX512-A and related alternatives addressing perceived limitations in one or more of these standards. The control architecture includes a wired solution in which a master controller has all-wired connections for the digital communications of control data to a plurality of slave devices, referred to herein as a wired control architecture. To extend such a wired control architecture from a master controller to slave devices without a wired connection, even when wired slave devices are not present, a compatible wireless control architecture is used in cooperation with the wired control architecture to derive/compose compatible digital wireless communication signals from the wired communications signals and convey them, at least in part, from the master controller to one or more wireless slave devices lacking a complete wired connection to the master controller.

As used herein, the terms “discrete integrated circuit (DIC)” means an integrated circuit (IC) or assembly such as a microchip, a microcontroller, a package-on-package system, a programmable device package, an Application Specific Integrated Circuit (ASIC) and/or a System on a Chip (SOC), discrete device/substrate/assembly, or the like that may include one or more of a microcontroller/microprocessor/digital signal processor, memory, timing sources, peripherals, timers, digital and analog input/output interfaces (including for example serial peripheral interface (SPI) and the like, and voltage regulators and power management circuits that DIC is specified to the controller manufacturer and configured to implement a wireless control architecture compatible with a wired control architecture implemented by an associated master controller. The controller manufacturer provides a DIC-compatible electromechanical interface (e.g., a socket, surface mount, through hole architecture or other support system providing electronic and mechanical communication and compatibility between the DIC and the solution interoperating with the DIC) in communication with a central processing unit (CPU) of the controller. When the manufacturer is ready to implement a wireless solution, the DIC is installed into the DIC-compatible electromechanical interface. Different wireless solutions and/or protocols are enabled by the manufacturer's choice of IC that is installed. Some implementations may include an end-user upgradeable solution, which will exclude certain types of electromechanical interfaces that do not permit a user to simply and easily exchange one DIC for another. In such a case some type of socket solution may be preferred over a soldered solution. Some implementations may focus on reducing costs, in which reducing component counts and improving manufacturability—in which case a manufacturer may prefer to solder the DIC in place to eliminate the socket. In another implementation, electrical and signal interfaces to the DIC-compatible electromechanical interface are specified as a standard allowing different adapter vendors to each manufacture a version of their solution into a DIC. The manufacturer is enabled to switch one DIC from one vendor for a DIC of another vendor without significant redesign of its controller to achieve the desired benefits of the new DIC. In still another implementation, a vendor's wireless solution, whether implemented as a DIC, may provide some resource off-loading allowing the wireless adapter implementation to boost the performance of the controller. This would enable the manufacturer of the controller to implement a robust wireless solution without necessarily increasing the manufacturer-provided processing resources of its controller. For example, in some instances a controller is interested in narrow range of channels from the possible control architecture (e.g., DMX) channel set. The wireless adapter could provide a filtering function to isolate the desired channels and provide the controller processor with a reduced set of data for processing. The controller processor in this sense is in reference to a host processor of the master controller/fixture that offloads some of the processing to the DIC.

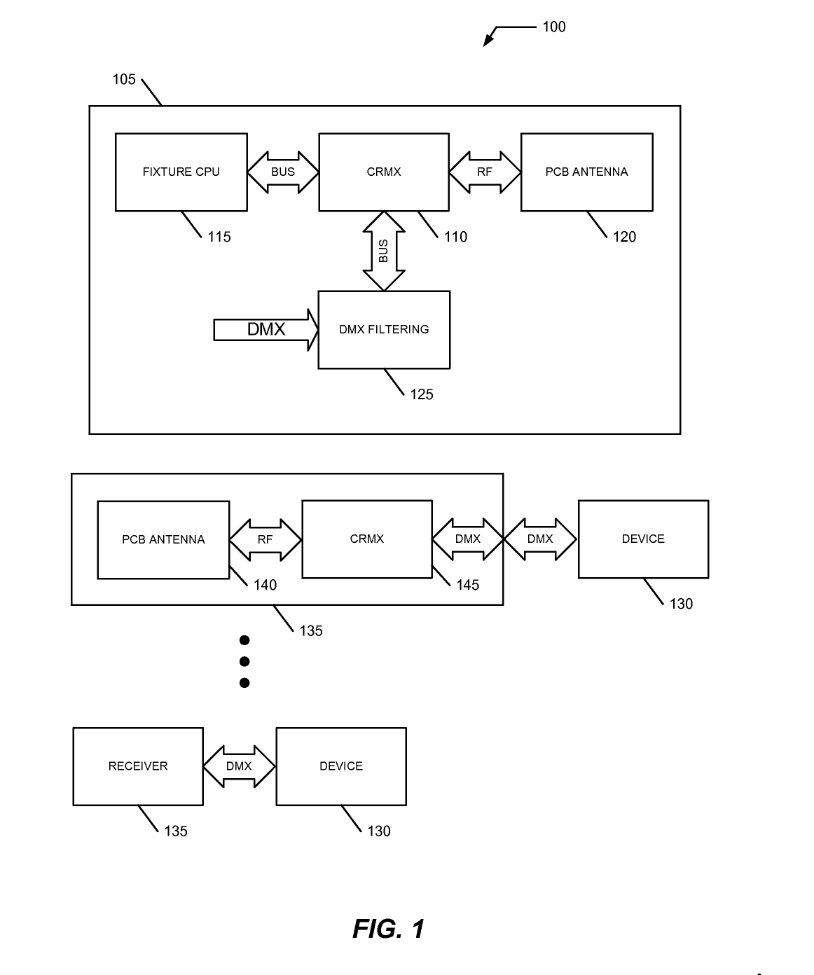

FIG. 1 illustrates a wireless digital control system 100 including a DMX fixture 105 incorporating a wireless IC 110. DMX fixture 105 also includes a fixture CPU 115, a PCB antenna 120, and an optional DMX filtering module 125. System 100 further includes one or more wirelessly-controlled slave devices 130. Each slave device 130 is associated with a wireless receiver 135. Wireless receiver 135 includes a PCB antenna 140 communicated to a DMX encoder function 145.

DMX fixture 105 is a master controller implementing DMX-standard control architecture for controlling slave device(s) 130. Fixture CPU 115 includes a stored program processor executing instructions retrieved from a fixture memory to effectuate this desired control using DMX commands. In a preferred implementation, wireless IC 110 also includes a second stored program processor that executes instructions from a second memory, different from the fixture memory, to implement the vendor proprietary wireless encoding of DMX control signals. Wireless IC 110 converts these wireless signals into DMX commands using a wireless protocol that may, in some cases, be proprietary to a particular vendor providing the wireless IC 110. For example different vendors may have enhanced noise canceling features, or employ special frequency-hopping spread spectrum (FHSS) technology that use adaptive frequency hopping and cognitive coexistence, a technique to detect and avoid surrounding wireless systems, to avoid transmitting on occupied frequencies which improves the wireless implementation. Wireless IC 110 enables each vendor to provide its custom solution into a standardized package to implement its particular solution so that the manufacturer of DMX fixture 105 does not have to significantly redesign a PCB containing DMX fixture 105 components.

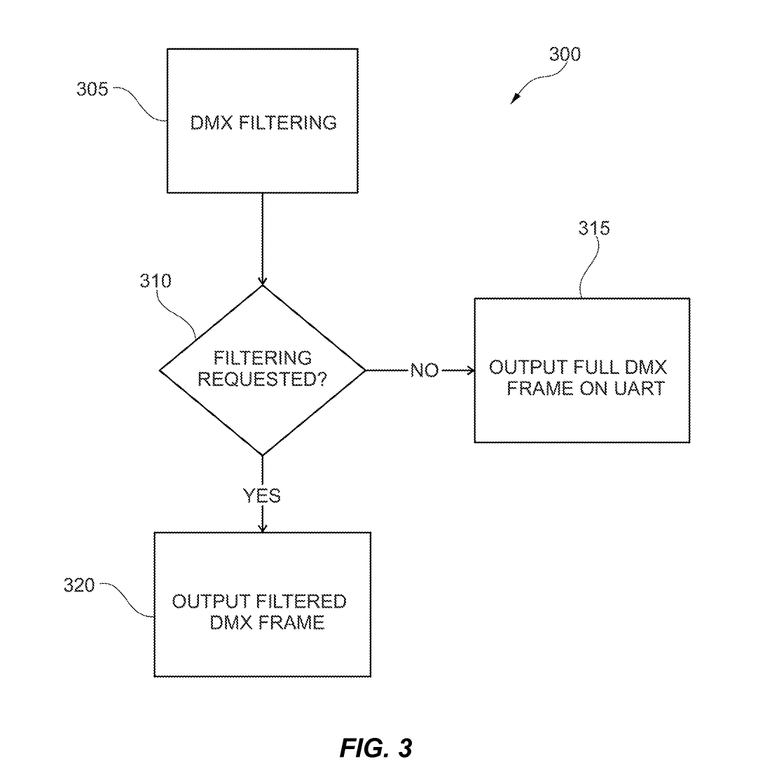

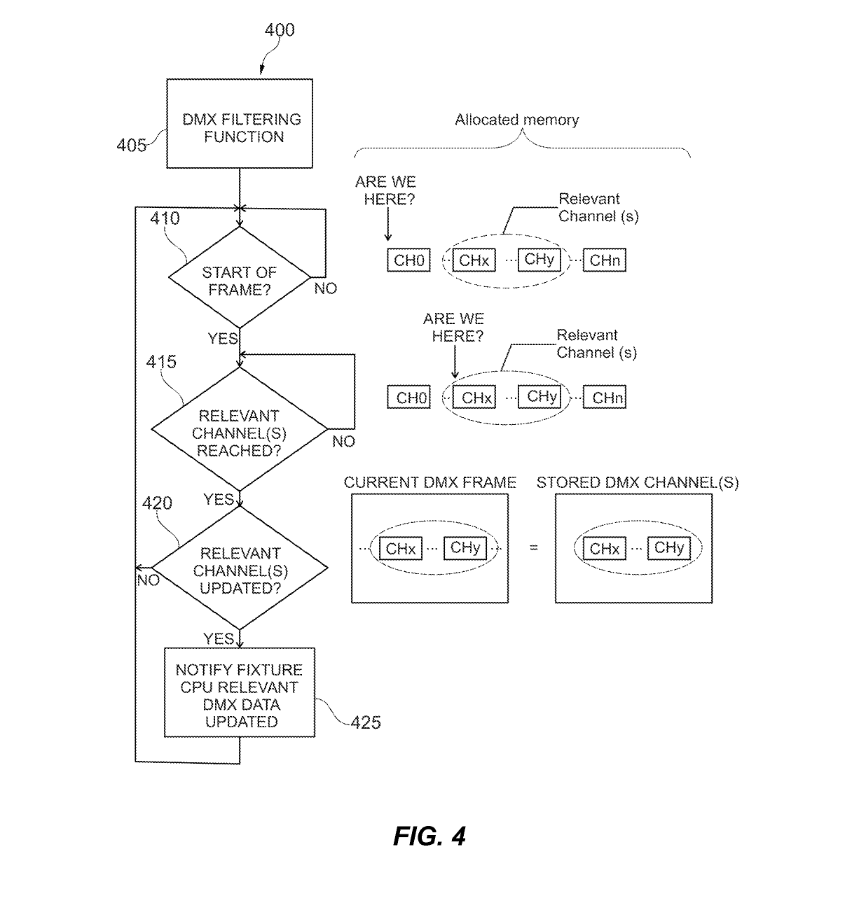

Wireless IC 110 communicates with fixture CPU 115 over a bus, such as a serial peripheral interface (SPI), or other interface (e.g., UART and the like). Wireless IC 110 prepares and transmits the necessary RF signal data to PCB antenna 120 for transmission to wireless receivers 135 to control any associated slave device(s) 130. Optional DMX filtering 125 may be implemented in many different ways, see for example the description herein including the discussion of FIG. 3 and FIG. 4.

Wireless IC 110 is illustrated as implementing CRMX, though other wireless protocols may be implemented. CRMX is an acronym for Cognitive Radio MultipleXer and is the first smart wireless system to automatically and continuously adapt to its surroundings in real time. CRMX was specifically developed to meet the demand for reliable, easy to use, and cost effective wireless lighting controls. LumenRadio launched its unique CRMX wireless technology for sale on an OEM basis in April of 2009. CRMX has since then been the only smart radio that automatically adapts to its surroundings in a smart way. CRMX has been developed by veterans in the wireless lighting control business with years of experience of the high demands of the entertainment and architainment businesses. CRMX was specifically developed to meet the demand for reliable, easy to use, and cost effective wireless lighting controls.

CRMX is now also available for OEM implementations as an even more cost effective and space effective single-chip solution providing wireless DMX receiving capabilities to the most cost and/or space sensitive applications. The CRMXchip DMX receiver is compatible with all LumenRadio CRMX transmitter as well as other transmitters for other open, standard, and/or proprietary protocols.

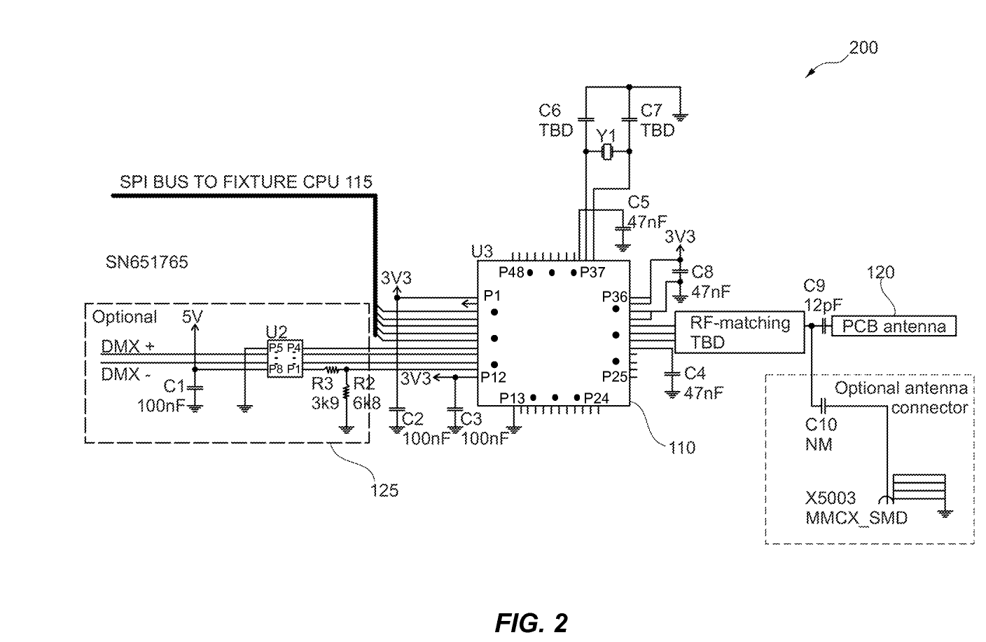

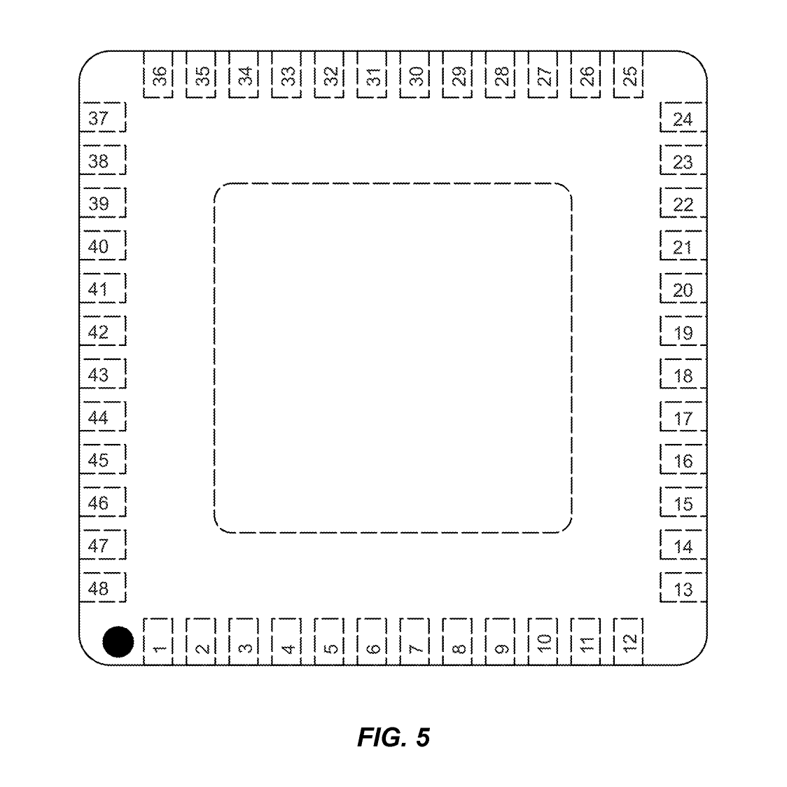

FIG. 2 illustrates details of a portion 200 of DMX fixture 105. Wireless IC 110 is interposed between fixture CPU 115 and PCB antenna 120 to implement a complete customizable, proprietary, and replaceable wireless protocol from a wireless DMX vendor into a DMX control fixture. U3 is a CRMXchip (DIC) having a pinout (pins P1−P48) identified herein (see, for example, FIG. 5 and associated discussion herein) and U2 includes a differential bus transceiver, for example SN65176B manufactured by Texas Instruments, and having pinouts P1-P8 as follows:

| Pin | Function |
|---|---|
| P1 | R—Receiver |
| P2 | R̅E̅—Receiver Enable |
| P3 | DE—Driver Enable |
| P4 | D—Driver |
| P5 | GND—Ground |
| P6 | A—Differential Signal (+)—DMX+ |
| P7 | B—Different Signal (−)—DMX− |
| P8 | VCC—Voltage |

In operation, a controller manufacturer creates its desired control solution as was typically done except for the inclusion of an electromechanical interface or the like that accepts custom wireless IC 110 from a different vendor. The manufacturer builds its solution and incorporates wireless IC 110 for the desired benefits associated with its use. Later, the manufacturer obtains a different wireless IC 110, from the same or different vendor, and substitutes it in place of the previous wireless IC 110 to implement a different set of associated benefits. In a preferred embodiment, this is possible by standardizing the communication physical (e.g., electromechanical interface arrangement) and electrical requirements (e.g., power and data interface) between fixture CPU 115 and PBA antenna 120 and conforming wireless IC 110 from each of these candidate vendors to these requirements.

FIG. 3 illustrates a filtering function decision process 300. Filtering function decision process 300 allows a wireless adapter, whether implemented as wireless IC 110 or a separate discrete solution in combination with a DMX controller, to reduce DMX processing resource requirement for the DMX controller. In some cases the DMX controller is interested in a subset of DMX channels, particularly whether data in one or more specific channels, has changed. The wireless adapter, preferably implemented in wireless IC 110, provides filtering function decision process 300.

Process 300 includes step 305-step 320. Step 305 initializes a DMX filtering environment including allocating an area of memory for filtered channel values. After step 305, process 300 executes step 310 to test whether filtering has been actually requested and enabled. When the test at step 310 is negative (“NO”), process 300 executes step 315 to output the full DMX frame on the bus (e.g., SPI or UART) to fixture CPU 115. However, when the test at step 310 is affirmative (“YES”), process executes step 320 and outputs only a windowed portion of the full DMX frame on the bus to fixture CPU 115, and then only when any value in the windowed portion of the full DMX frame has changed since the last frame. In this way, fixture CPU 115 is not tasked with processing a full DMX frame, and further, does not process any DMX frame data unless and until a value in the windowed portion actually changes. A lower powered, in the sense of processing capability, fixture CPU 115 may thus be used as compared to an implementation where the fixture CPU is responsible for processing each full DMX frame.

FIG. 4 illustrates details of a DMX filtering function 400 and representative relevant channels in a memory allocation provided by filtering function decision process 300. Function 400 includes step 405-step 425. Step 405 initializes the DMX filtering function and accesses the relevant parts of the memory and data buffers. This initialization includes identification of the area of memory for the DMX frame data, which channel or channels are to filtered (i.e., the location and size of the windowed portion which may include, for example, an identification of a beginning channel x and an ending channel y), among other initialization tasks. After step 405, function 400 executes a step 410 to test whether the filtering function has located a start of the DMX frame. When the test is negative (“NO”), function 400 returns to step 410 until the test is affirmative (“YES”).

When the test at step 410 is affirmative, function 400 executes step 415 which includes another test. The test at step 415 determines whether a frame pointer into the DMX frame memory has located the beginning of the windowed portion (e.g., beginning channel x). When the test at step 415 is negative, function 400 loops back to step 415 until the test is affirmative.

When the test at step 415 is affirmative, function 400 executes step 420 which includes another test. The test at step 420 compares the values of the data in the windowed portion of the current DMX frame to stored values from an earlier DMX frame. When the test at step 420 is negative (meaning that none of the values of windowed portion of the current DMX channel have changed from the previous stored values) then function 400 returns to step 410 to analyze the subsequent DMX frame which becomes the new current DMX frame.

When the test at step 420 is affirmative, function 400 executes step 425 which notifies fixture CPU 115 of the changed DMX values in the windowed portion of the current DMX frame. This notification may be performed in a number of ways, including sending information to fixture CPU 115 over the wireless IC 110/fixture CPU 115 interface (e.g., SPI, UART, or the like) however these devices are intercommunicated.

In an embodiment of the present invention, a DMX compliant lightning fixture includes a wireless DMX compliant IC integrated in a DMX compliant fixture, the wireless DMX compliant IC controlling said DMX compliant fixture with the wireless DMX compliant IC with auto jumping frequency that minimizes interference and with the IC having a control interface for function setting; the control interface having a function to disconnect established wireless link and a man/machine interface (MMI) to indicate a wireless DMX status; the MMI indicating an established wireless link to a wireless DMX source, indicating loss of wireless link

Some implementations include the IC having balanced RF connections, the control interface enabling the fixture to read a status of the IC, the fixture including a physical connection for DMX, and the connection allowing for either DMX in or out.

A lighting fixture (or an entertainment lighting fixture) including a wireless DMX IC controlling the fixture, the IC providing a digital data interface for controlling the fixture, the IC utilizing an automatic frequency hopping method improving reliability, the frequency hopping method including an adaptive scheme reducing interference, the IC providing a method for connecting to a signal level converter, the IC having a digital interface for configuring the IC, the interface providing status about the radio link, with the IC having a digital interface for controlling the radio link.

FIG. 5 illustrates a representative pin assignment and functions for an implementation of an IC for a CRMXchip QFN48. A center pin pad of the chip is connected to ground (0V). Table I identifies a representative pin assignment but other implementations may include different pin assignments.

TABLE I
CRMXchip Pin Assignment/Function

| Pin | Name | Function | Description |
|---|---|---|---|
| 1 | VDD | Power | Power supply (3.3 V) |
| 2 | N.C. | No connection | Reserved for future use, |
| | | | do not connect |
| 3 | /IRQ | Digital output | Interrupt signal, active low |
| 4 | /CS | Digital input | Chip select, active low |
| 5 | SCK | Digital input | SPI clock |
| 6 | MOSI | Digital input | SPI Master Out, Slave In |
| 7 | MISO | Digital output | SPI Master In, Slave Out |
| 8 | DMX_TXD | Digital output | DMX TXD |
| 9 | RS485_DE | Digital output | RS485 driver control signal |
| 10 | /RS485_RE | Digital output | RS485 driver control signal |
| 11 | DMX_RXD | Digital input | DMX RXD (3.3 V max) |
| 12 | VDD | Power | Power supply (3.3 V) |
| 13 | VSS | Power | Ground (0 V) |
| 14 | RDI_LVL0 | Digital output | Radio level LED |
| 15 | RDI_LVL1 | Digital output | Radio level LED |
| 16 | RDI_LVL2 | Digital output | Radio level LED |
| 17 | RDI_LVL3 | Digital output | Radio level LED |
| 18 | RDI_LVL4 | Digital output | Radio level LED |
| 19 | N.C. | No connection | Reserved for future use, |
| | | | do not connect |
| 20 | DMX_LED | Digital output | DMX LED |
| 21 | LINKED | Digital output | Linked to transmitter LED |
| 22 | RF_LINK | Digital output | RF link LED |
| 23 | /RESET | Reset | Chip reset, active low |
| 24 | N.C. | No connection | Reserved for future use, |
| | | | do not connect |
| 25 | N.C. | No connection | Reserved for future use, |
| | | | do not connect |
| 26 | N.C. | No connection | Reserved for future use, |
| | | | do not connect |
| 27 | N.C. | No connection | Reserved for future use, |
| | | | do not connect |
| 28 | N.C. | No connection | Reserved for future use, |
| | | | do not connect |
| 29 | CAP1 | Analog output | Capacitor connection |
| 30 | RF_BIAS | Analog output | RF circuitry biasing |
| 31 | RF1 | RF | Differential antenna |
| | | | connection |
| 32 | RF2 | RF | Differential antenna |
| | | | connection |
| 33 | VSS | Power | Ground (0 V) |
| 34 | VSS | Power | Ground (0 V) |
| 35 | VDD | Power | Power supply (3.3 V) |
| 36 | VDD | Power | Power supply (3.3 V) |
| 37 | XTAL1 | Analog input | Connection for 16 MHz crystal |
| | | | or 16 MHz clock reference |
| 38 | XTAL2 | Analog output | Connection for 16 MHz crystal |
| 39 | CAP2 | Analog output | Capacitor connection |
| 40 | N.C. | No connection | Reserved for future use, |
| | | | do not connect |
| 41 | N.C. | No connection | Reserved for future use, |
| | | | do not connect |
| 42 | N.C. | No connection | Reserved for future use, |
| | | | do not connect |
| 43 | N.C. | No connection | Reserved for future use, |
| | | | do not connect |
| 44 | N.C. | No connection | Reserved for future use, |
| | | | do not connect |
| 45 | LINK_SW | Digital input | Link control switch input |
| 46 | STATUS_LED | Digital output | Status LED |
| 47 | N.C. | No connection | Reserved for future use, |
| | | | do not connect |
| 48 | N.C. | No connection | Reserved for future use, |
| | | | do not connect |

Pin 46 of this illustrated embodiment is assigned as a status LED pin (STATUS_LED). The status LED indicates the status of the radio module. The LED indicator pin is a 3.3V output pin capable of sourcing 20 mA. An appropriate current limiting resistor must be connected in series with the LED. An LED powered by this pin includes four modes: constant off, quick flash, slow flash, and constant on. Constant off provides a visual indication that the CRMXchip is not paired with any transmitter. Quick flash indicates that the CRMX is linked with a transmitter but has no active radio link. Slow flash indicates an active radio link but no DMX is present. Constant on indicates both an active radio link and that DMX data is present.

Other LED outputs include: Linked, RF Link, DMX, and Radio Level.

Linked: The Linked LED (LINKED) indicates whether the CRMXchip is linked to a transmitter or if it's available to be linked. High level (3.3V) on this pin indicated a linked state; low level (0V) indicates that the CRMXchip is not linked.

RF Link: A high level (3.3V) on the RF Link LED output (RF_LINK) indicates that the CRMXchip is within range from the transmitter it is linked to and that an active radio link from the transmitter is present.

DMX: The DMX LED (DMX_LED) indicates if a valid DMX stream is received from the transmitter. A high level (3.3V) indicates that DMX is present, a low level (0V) indicates that no valid DMX is present.

Radio level: CRMXchip has 5 output signals for controlling radio level LEDs in the form of a bar graph (RDI_LVL0-RDI_LVL4). Operation of these, and suggestion of LED colors, can be found in Table II.

TABLE II
LED colors

| Signal name | LED color | On when signal quality |
|---|---|---|
| RDI_LVL0 | Red | below ~10% |
| RDI_LVL1 | Amber/Yellow | above ~20% |
| RDI_LVL2 | Green | above ~40% |
| RDI_LVL3 | Green | above ~60% |
| RDI_LVL4 | Green | above ~80% |

Link switch input: The link switch input can be used to interface with a momentary closing push button to facilitate a simple user interface when not using the SPI interface to integrate into a fixture's menu system.

Please refer to the example schematic, e.g., FIG. 2, for details on how to connect the push button. This signal shall be pulled to 3.3V using an external 4.7 kOhm-10 kOhm resistor, when used, to ensure proper function.

The switch input has two functions: unlink the receiver from a transmitter or to force driver update mode. Please see Table III for details about the functions of the switch input.

TABLE III
Details of Link Switch Output

| Function | Conditions |
|---|---|
| Unlink from | Hold signal low (button pressed) |
| transmitter | for >3 seconds. |
| Force driver | Hold signal low (button pressed) |
| update mode | during power on. |

SPI Operation:

The control and data interface gives access to all features of the CRMXchip. The interface includes five 3.3V digital signals:

IRQ—Interrupt signal. Active low, configurable through the interrupt mask register.

CS—SPI Chip select, active low.

SCK—SPI clock input

MOSI—SPI data input

MISO—SPI data output

Interface Description

Bit and byte order: The data on the SPI bus is clocked with most significant bit first. All multi-byte register data are sent in big-endian byte order.

Clock polarity: Data is valid in the high-to-low transition of SCK. This is also known as the clock being active low with valid data on the leading clock edge.

Maximum clock speed: The maximum clock speed supported by CRMXchip is 2 MHz. Clock speeds above this limit may result in unexpected behavior.

Setup time: The SPI slave unit has a setup time of 4 μs after the high-to-low transition of the CS signal.

SPI Operation

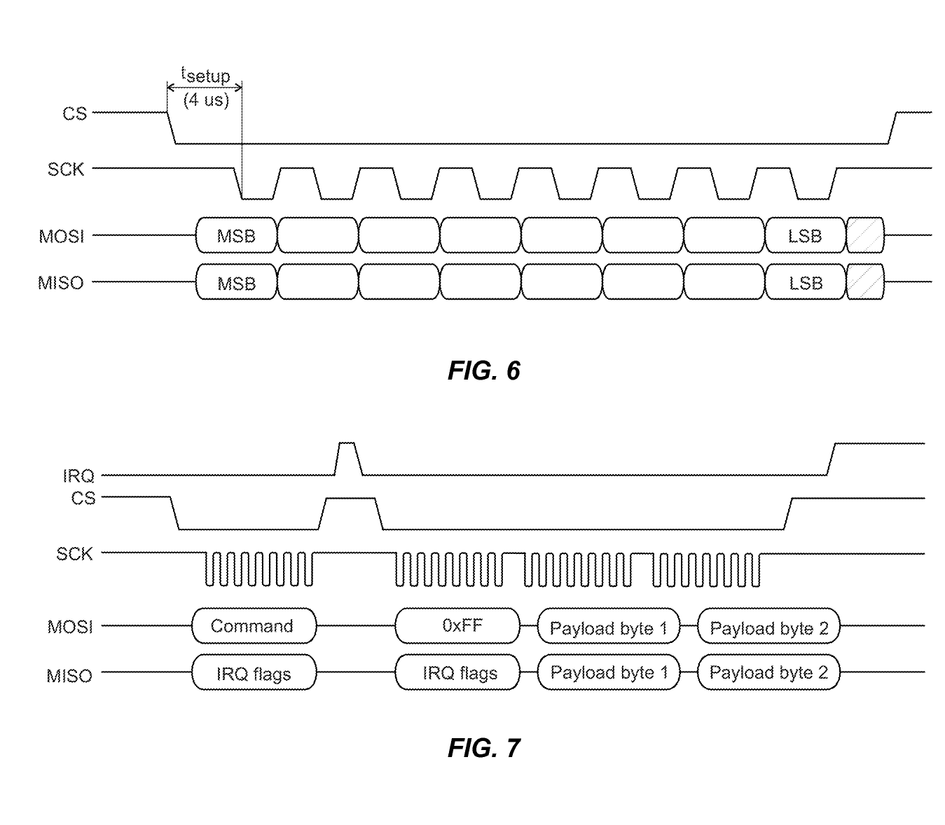

SPI transactions: All SPI transactions start with a high-to-low transition on the CS pin. The CS pin must be held low during the entire SPI transaction. The IRQ_FLAGS register is always shifted out as the first byte of each transaction. See FIG. 6 for an example of an SPI transaction having a setup time (tₛₑₜᵤₚ, of 1 f about four micro seconds.

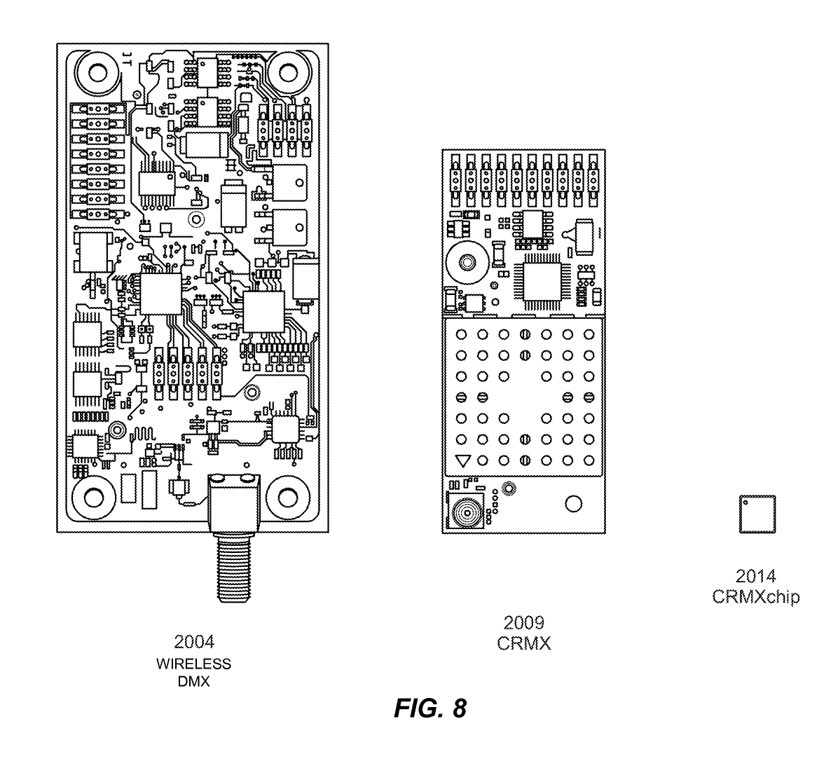

SPI commands: All SPI command sequences, except for the NOP command, of the illustrated embodiment include two SPI transactions. The first transaction shall be one byte long, this is the command byte. The second transaction is the payload. The second transaction must not be started until the CRMXchip has confirmed the command by a high-to-low transition on the IRQ pin. The first byte being sent to CRMXchip in the second transaction will be ignored, however it is suggested this byte is being sent as 0xFF. See FIG. 7 for an example full SPI command sequence.

NOTE: Bit 7 in the IRQ flags register MUST be observed. A ‘1’ in this bit means that the SPI slave module is unable to process the current transaction, and the full command sequence MUST be restarted—this means sending the command transaction again.

The SPI interface is a standard SPI interface with maximum data rate of 2 Mbps. The available SPI commands are listed in Table IV. All SPI commands must be started by a high-to-low transition on the CS pin, it is not possible to perform multiple commands in one SPI transaction. The IRQ_FLAGS register is always shifted out on the MISO pin simultaneously to the SPI command is shifted in on the MOSI pin.

TABLE IV
Available SPI Commands

| | Binary | |
|---|---|---|
| Command | value | Comment |
| WRITE_REG | 01AA AAAA | Write to a register. AAAAAA = |
| | | 6 bit register address |
| READ_REG | 00AA AAAA | Read from a register. AAAAAA = |
| | | 6 bit register address |
| READ_DMX | 1000 0001 | Read the latest received DMX values |
| | | from the window set up by the |
| | | DMX_WINDOW register. |
| READ_ASC | 1000 0010 | Read the latest received ASC frame. |
| NOP | 1111 1111 | No operation. Can be used as a |
| | | shortcut to read the IRQ_FLAGS |
| | | register. |

Table V includes a register map for the CRMXchip. All undefined bits in Table V shall be considered reserved for future use—don't care when read, write as 0. Do not read or write undefined registers—doing so could result in undefined behavior.

TABLE V
Register Map

| Address | | | | Reset | |
|---|---|---|---|---|---|
| (hex) | Mnemonic | Bit # | Type | value | Description |
| 00 | CONFIG | | | | Configuration register |
| | UART_EN | 0 | R/W | 1 | Enable UART output of DMX frames |
| | Reserved | 1-6 | — | — | Reserved for future use |
| | RX_ENABLE | 7 | R/W | 1 | Enable wireless DMX reception |
| 01 | STATUS | | | | Status register |
| | LINKED | 0 | R/W | — | 0 = Not linked, 1 = Linked to TX (or linking) |
| | | | | | Write 1 to unlink |
| | RF_LINK | 1 | R | 0 | 0 = No radio link, 1 = Active radio link |
| | DMX | 2 | R | 0 | 0 = No DMX from TX, 1 = DMX from TX |
| | Reserved | 3-6 | — | — | Reserved for future use |
| | UPDATE_MODE | 7 | R | 0 | 0 = chip operational, 1 = In driver update mode |
| 02 | IRQ_MASK | | | | IRQ mask register |
| | RX_DMX_IRQ_EN | 0 | R/W | 0 | Enable DMX frame reception interrupt |
| | LOST_DMX_IRQ_EN | 1 | R/W | 0 | Enable loss of DMX interrupt |
| | DMX_CHANGED_IRQ_EN | 2 | R/W | 0 | Enable DMX changed interrupt |
| | RF_LINK_IRQ_EN | 3 | R/W | 0 | Enable radio link status change interrupt |
| | ASC_IRQ_EN | 4 | R/W | 0 | Enable alternative start code interrupt |
| | Reserved | 5-7 | — | — | Reserved for future use |
| 03 | IRQ_FLAGS | | | | IRQ flags register |
| | RX_DMX_IRQ | 0 | R | 0 | Complete DMX frame received interrupt |
| | LOST_DMX_IRQ | 1 | R | 0 | Loss of DMX interrupt |
| | DMX_CHANGED_IRQ | 2 | R | 0 | DMX changed in DMX window interrupt |
| | RF_LINK_IRQ | 3 | R | 0 | Radio link status change interrupt |
| | ASC_IRQ | 4 | R | 0 | Alternative start code frame received interrupt |
| | Reserved | 5-6 | — | — | Reserved for future use |
| | SPI_DEVICE_BUSY | 7 | R | 0 | SPI slave device is busy and cannot comply with |
| | | | | | command. Command sequence MUST be |
| | | | | | restarted. |
| 04 | DMX_WINDOW | | | | Status register |
| | START_ADDRESS | 0-15 | R/W | 0 | Start address of DMX window |
| | WINDOW_SIZE | 16-31 | R/W | 512 | Length of DMX window |
| 05 | ASC_FRAME | | | | ASC frame info register |
| | START_CODE | 0-7 | R | 0 | Start code of received ASC frame |
| | ASC_FRAME_LENGTH | 8-23 | R | 0 | Length of received ASC frame (0-512) |
| 06 | LINK_QUALITY | | | | Radio link quality register |
| | PDR | 0-7 | R | — | Packet delivery rate 0 = 0%, 255 = 100% |
| 10 | VERSION | | | | Version register |
| | DRIVER_VERSION | 0-31 | R | — | Driver version |
| | CHIP_REVISION | 32-64 | R | — | Chip revision |

Interrupts: The IRQ pin is used to indicate that there is one (or more) pending interrupt that have been enabled through the IRQ_MASK register. The IRQ pin is also used to indicate that the SPI slave is ready to receive the second transaction of an ongoing SPI command sequence.

The IRQ pin will always go high (inactive) after a successful SPI transaction. If any interrupts are pending, or when the chip is ready for the second transaction in a SPI command sequence it will be indicated through a high-to-low transition on the IRQ pin.

RX_DMX_IRQ: Asserted when a complete DMX frame has been received. Cleared by issuing a READ_DMX command sequence.

LOST_DMX_IRQ: Asserted when DMX stream is lost. This may be an effect of losing radio link, or if DMX stream in to the transmitter is terminated (for instance the DMX cable to the transmitter is unplugged). Cleared by reading the STATUS register.

DMX_CHANGED_IRQ: Asserted when a complete DMX frame has been received and any slot within the DMX window has changed value. Cleared by issuing a READ_DMX command sequence.

RF_LINK_IRQ: Asserted whenever the state of the radio link has changed. This may be: radio link is lost, radio link is established, receiver got paired to transmitter, receiver got unpaired from transmitter; or cleared by reading the STATUS register.

ASC_IRQ: Asserted when a complete ASC frame has been received. Cleared by reading the ASC_FRAME register.

DMX window: The DMX window feature allows a host CPU to set up a span of DMX slots (aka. a DMX window) that the host is interested of. This will reduce the load of the host since it does not need to buffer and parse the entire DMX frame.

Instead the host can get an interrupt request (DMX_CHANGED_IRQ) from CRMXchip whenever data has changed inside the DMX window.

RX_DMX_IRQ is not affected by the settings of the DMX window.

Reading DMX Data Over SPI

When reading DMX data over SPI, the longest block of data possible to read is 128 bytes. If it is required to read more than 128 bytes this must be done by performing multiple consecutive READ_DMX command sequences.

The internal data block counter is reset when the end of the DMX window is reached, or if any other command is being sent to the SPI slave.

DMX Interface

The DMX interface of the CRMXchip includes 4 digital (0-3.3V) signals that can be used to interface an RS485 driver IC compliant with the ANSI E1.11 DMX512-A standard to facilitate a DMX512-A compatible interface. Please refer to the example schematic of FIG. 2 for details on how to connect an RS485 driver IC.

The DMX interface can also be used for CMOS/TTL level directly interfacing for instance a host CPU.

NOTE: Signal on RXD pin must NOT exceed 3.3V! If 5V signal is used, a level shifting circuit must be used. Please see example schematics for details on how to use a 5V IC.

DMX Frame Rate and Size

CRMXchip will auto sense the DMX frame rate and frame size and accept all variations that are within the USITT DMX-512 (1986 & 1990) and 512-A standards.

Minimum DMX frame size is 1 slot and maximum is 512 slots.

Minimum DMX frame rate for normal operation is 0.8 frames per second and maximum is 830 frames per second.

Input frame rates below 0.8 frames per second, i.e. more than 1.25s has elapsed since the last frame, will be treated as a loss of DMX and the RS485 driver IC will be set in a high-impedance/tri-state mode until another DMX frame is detected.

CRMX will propagate DMX through the system maintaining the input frame rate and frame size with the exception of frame rates that exceed those allowed by the DMX 512-A standard.

Input DMX frame rates above 830 frames per second will propagate through the system at 830 frames per second to ensure that the DMX output is compliant with the DMX512-A standard.

DMX Start Codes

DMX packets with start codes other than the DMX default 0x00 (also known as the Null Start Code, or NSC) and the RDM start code 0xCC will be propagated through the system, and subject to the same rules and limitations, as the null start code packets. Such frames are called Alternate Start Code, or ASC, frames.

Alternate Start Code Frames

ASC frames can be read separately from the SPI interface. The ASC_FRAME register contains basic information about the last received ASC frame. The information available in this register is start code and length (number of slots).

Reading ASC Data Over SPI

When reading ASC data over SPI, the longest block of data possible to read is 128 bytes. If it is required to read more than 128 bytes this must be done by performing multiple consecutive READ_ASC command sequences.

The internal data block counter is reset when the end of the ASC frame is reached, or if any other command is being sent to the SPI slave.

Versions

This section describes the data that can be read from the VERSION register.

Chip Revision

Chip revision is a 32 bit number that shall be translated into a HEX string. It will match the revision number of the chip marked on the package. For instance the value 0x000A0001 corresponds to chip revision “000A0001”.

Driver Version

The driver version is interpreted as x.y.z.v where X is the most significant byte of the 32 bit version number and v is the least significant byte.

Radio Driver Update

The radio drivers in CRMXchip can be updated for future updates. This can be performed either via SPI from a host processor in a fixture, or by streaming over the air or via the DMX interface.

Representative electrical specifications for CRMXchip are identified in Table VI.

TABLE VI
Electrical Specifications for CRMXchip

| Symbol | Parameter | Min. | Typ. | Max. | Unit |
|---|---|---|---|---|---|
| V_{DD} | Supply voltage | 3.0 | 3.3 | 3.6 | V |
| I_{DD} | Supply current (Not | | | 40 | mA |
| | including current for | | | | |
| | driving LEDs) | | | | |
| T_{A} | Operating temperature | −20 | | 75 | ° C. |
| V_{IL} | Input voltage logic | 0 | | 0.9 | V |
| | low | | | | |
| V_{IH} | Input voltage logic | 2.5 | | 3.3 | V |
| | high | | | | |
| I_{LED} | Max current drive on | | | 5 | mA |
| | LED pins | | | | |
| f_{range} | Operating frequency | 2402 | | 2480 | MHz |
| | range | | | | |
| RXₛₑₙₛ | Receiver sensitivity | | −93 | | dBm |
| | (0.1% BER) | | | | |
| Z_{RF} | Differential impedance | | 15 + j*85 | | Ω |
| | from antenna pins RF1 | | | | |
| | and RF2 seen into | | | | |
| | matching network. | | | | |
| DMX_{size} | DMX frame size | 0 | | 512 | |
| | (excluding start code) | | | | |
| DMXᵣₐₜₑ | DMX frame rate | 0.8 | | 830 | fps |

FIG. 8 illustrates a progression in development of wireless DMX control systems. There are 3 wireless DMX controllers illustrated—a design of an early controller from 2004, a 2009 design by LumenRadio AB, and a 2014 implementation of the present invention in an IC. The size and complexity of the solutions decrease providing surprising results for direct integration of a wireless DMX solution.

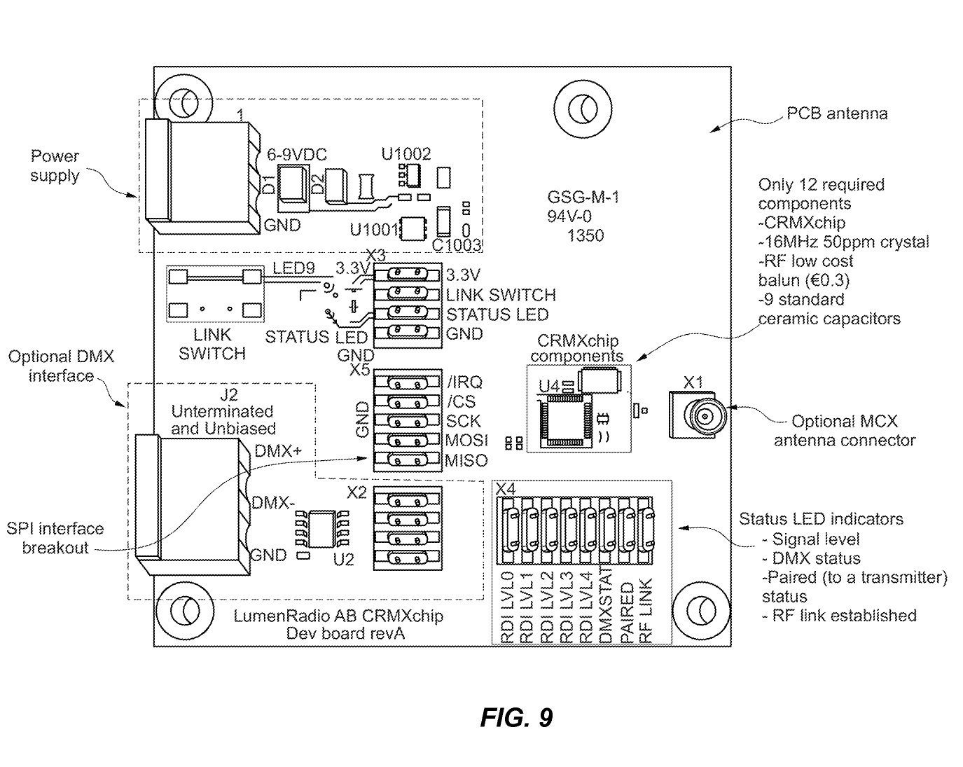

FIG. 9 illustrates an implementation of a wireless DMX control system of the present invention. The user-replaceable IC (e.g., the CRMXchip) is implemented on a reference board with twelve (12) components: the IC, a crystal (e.g., a 16 MHz 50 ppm crystal), and RF lost cost Balun ( [symbol] 0.3) and 9 standard ceramic capacitors. Other features of the reference board may include status LED indicators: signal level, DMX status, paired (to a transmitter) status, and RF link established. The reference board may further include an optional DMX interface, an SPI interface breakout, a power supply interface, a PCB antenna, and an optional MCX antenna connector.

SPI options include: basic configuration, DMX window, DMX interrupts (loss of DMX, alternate start code, and other desired or necessary features), status, radiofrequency (RF) quality, and driver versions.

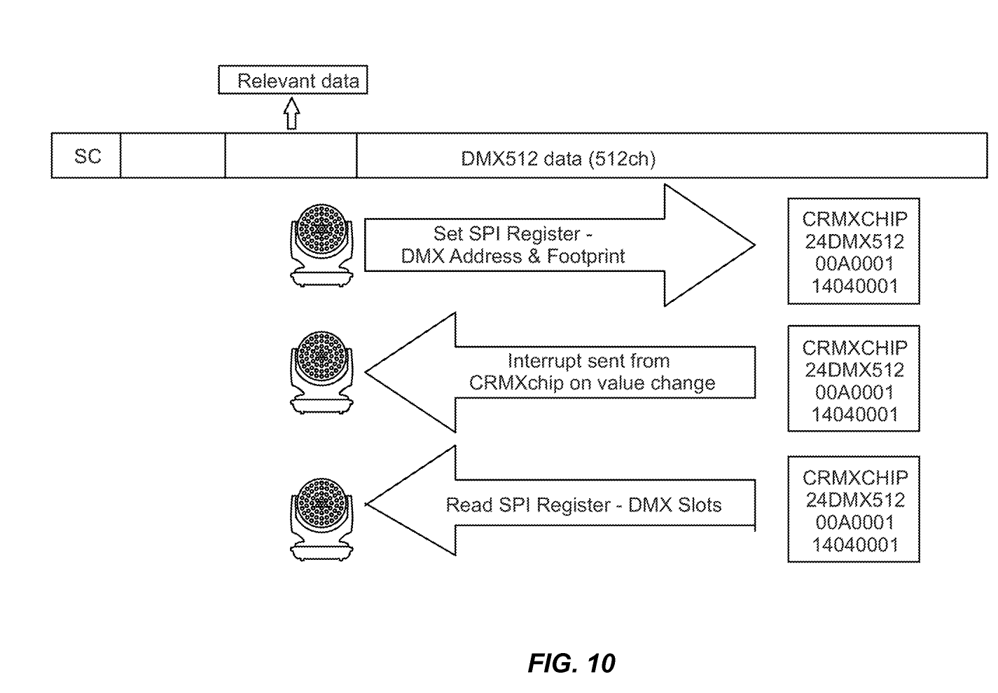

FIG. 10 illustrates a process for using a DMX window of the present invention. FIG. 8 illustrates a portion of a DMX packet beginning with a start code (SC) that is a beginning of the actual data stream for DMX512 data (which may include up to 512 channels of data). Embodiments of the present invention define a DMX window as a subset of this data stream (e.g., the relevant data).

A DMX controlled device sets an SPI register of the IC with a particular DMX address and footprint (e.g., window size/length). The IC will communicate to the controlled device an occurrence of an interrupt when there is a value change within the DMX window. The controlled device then reads an SPI register for the data in the desired DMX slots.

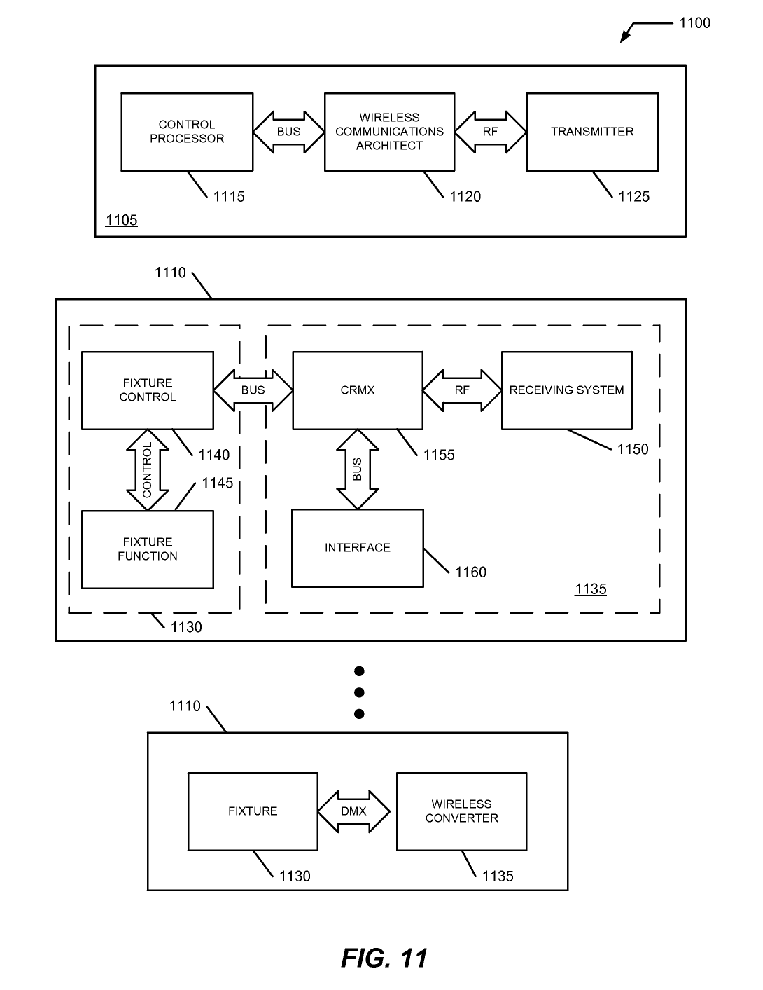

FIG. 11 illustrates an implementation of a wireless digital control system 1100 including a master controller 1105 communicating wirelessly to one or more slave devices 1110 using a control architecture. Master controller 1105 includes a control processor 1115 that is a stored program controller accessing and executing program instructions from a memory. Control processor 1115 produces control data that is to be communicated wirelessly to the one or more slave devices 1110. This communication will be performed, in the illustrated embodiment, by transmitting digital wireless control signals compliant with one or more particular wireless control architectures. The control data may be compliant with a wired control architecture, such as DMX.

A wireless communications architect 1120 is responsive to the control data from control processor 1115 to define digital wireless control signals compliant with the implemented wireless control architecture. A transmitter 1125, which may include an antenna for wireless transmission of the digital wireless control signals, communicates wirelessly the digital wireless control signals defined by wireless communications architect 1120. Wireless communications architect 1120 may be implemented in many different ways, such use of the CRMX defined above, some other DIC, or IC, or other assembly, discrete assembly, or chip solution, compliant with one or more implemented wireless control architectures recognized by any of the one or more slave devices 1110.

Each slave device 1110 includes a fixture component 1130 and a wireless converter 1135. Fixture component 1130 is a remote light or some other function that is to be remotely and wireless controlled by master controller 1105. While a preferred implementation is to integrate wireless converter 1135 directly onto a printed circuit board (PCB) or other monolithic foundation mechanically and electrically supporting fixture component 1130, some implementations may have varying levels of integration. When integrated, wireless converter 1135 may be largely implemented as a DIC integrated with fixture component 1130 and a receiving mechanism/system compatible with transmitter 1125 (e.g., an antenna) as described herein.

Fixture component 1130 includes a fixture control 1140 communicating control data to one or more fixture functions 1145. A primary goal of wireless digital control system 1100 is for control processor 1115 to manipulate wirelessly fixture functions 1145 of all slave devices 1110 efficiently.

Fixture control 1140 includes a stored program processor accessing program instructions from a memory to respond to a set of digital control inputs provided by wireless converter 1135 when controlling fixture function(s) 1145. Fixture function(s) 1145 is/are the remotely manipulable operations of fixture component 1130. These operations may include many different aspects of remote wireless control as well-known.

Wireless converter 1135 includes a receiving system 1150 coupled to a discrete integrated circuit (DIC) 1155, such as the CRMX DIC described herein, and may include an optional communications interface 1160 coupled to DIC 1155, such as the fully compliant DMX interface described herein. Some or all of the fixture elements, e.g., fixture control 1140 and/or fixture function 1145, are coupled to communications interface 1160 for operation.

For one-way control architectures, receiving system 1150 may be a receiver including receiving components and an antenna. For two-way control architectures, receiving system 1150 includes a transmitter having transceiving components and an antenna.

DIC 1155 implements one or more wireless control architectures compliant with the control architecture defined by wireless communications architect 1120. While master controller 1105 typically produces digital wireless control signals compliant with a single wireless control protocol, there are different digital wireless control signals that may be produced in general. The more versatile that DIC 1155 is in recognizing and including a compliant and/or compatibility mode with multiple wireless control architectures permits slave device 1110 to operate in different systems 1100 and respond to different master controllers 1105 and different sets of digital wireless control signals when producing a set of digital control inputs for fixture component 1130.

As described herein, DIC 1155 may implement a filtering mode. DIC 1155 is capable of providing fixture components 1130 with a full set of digital control inputs (no filtering or filtering disabled) or may provide an identified subset of the full set of digital control inputs (with filtering or filtering enabled). A filter enable signal, for example provided by fixture control 1140 or master controller 1105, controls the optional filtering system and allows DIC 1155 to off-load some of the digital control input processing allowing fixture control 1140 to be more responsive and/or to have fewer processing resources available. As illustrated, DIC communicates an output set of digital control inputs to fixture control 1140 using a bus structure, for example, serial peripheral interface (SPI) bus. Some or all of the full set of digital control signals converted by DIC from the set of digital wireless control signals (depending upon filtering mode) are communicated using the SPI bus. For some control architectures, for example DMX, SPI does not implement a fully compatible solution which may be implemented using interface 1160 when necessary/desired. Other control architectures may have similar limitations/constraints and a similar interface 1160 may be made available to fixture components 1130 when necessary or desirable.

In operation, master controller 1105 produces digital wireless control signals that are received by one or more slave devices 1110. DIC 1155 of each slave device 1110 is responsive to the set of digital wireless control signals and produces a set of digital control inputs (filtered or unfiltered) to fixture control 1140 to appropriately control (e.g., if addressing information identifies the particular fixture/function) an associated fixture function 1145.

The system and methods above has been described in general terms as an aid to understanding details of preferred embodiments of the present invention. In the description herein, numerous specific details are provided, such as examples of components and/or methods, to provide a thorough understanding of embodiments of the present invention. For example, a specific reference is made to DMX512 in some of the disclosed embodiments. The present invention is not limited to DMX and other standards and interfaces may be adapted as well, including System Information Packets (SIP), Remote Device Management (RDM), Architecture for Control Networks (ACN), digital addressable lighting interface (DALI), Art-Net, and the like. In other embodiments of the invention, an improved frequency hopping architecture is described as being enabled by use of a particularly configured wireless IC. The incorporated U.S. Pat. No. 8,457,023 describes a method for selecting operating frequency channels having frequency parameters, such as a frequency interval or at least one carrier frequency, for a network communicating data over a shared medium and U.S. Pat. No. 8,565,176 issued 22 Oct. 2013 relates to a wireless network including at least two subnets and each subnet including a plurality of units configured to wirelessly communicate with each other, both patents are hereby expressly incorporated by reference thereto in their entireties for all purposes. The DIC of the present invention may implement other wireless architectures. Further, in some embodiments the DIC is described as preferably integrated directly into a fixture PCB, or use of an electromechanical interface for efficient replacement (a direct implementation, including end-user replaceability to implement different control architecture(s)). Some embodiments may include a connector with the fixture that replaceably accepts a module that in turn is provided with the DIC for an indirect implementation.

One of the disclosed embodiments is referred to herein as a CRMXchip being a non-exhaustive representative implementation of a DIC and implements the CRMX technology described herein. Other DICs of the present invention may include other specifics of implementation, whether implementing CRMX or other protocol. The reference to the representative CRMXchip is not done for limitation of the present invention but to aid in the understanding of how a particular protocol may be enabled by a DIC in the context of the present invention.

Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An assembly responsive to a set of digital wireless control signals, comprising:
a control fixture including a fixture processor and a fixture memory, said control fixture configured to implement a control architecture that produces a set of digital control signals compliant with said control architecture derived from a set of digital control inputs, said fixture processor executing a first set of program instructions accessed from said fixture memory to implement said control architecture;
an antenna, coupled to said control fixture, receiving wirelessly the set of digital wireless control signals; and
a discrete integrated circuit (DIC), electrically communicated to said fixture processor and to said antenna, configured to implement a wireless control architecture responsive to the set of digital wireless control signals and produce said set of digital control inputs for said control fixture, said wireless control architecture different from said control architecture.

2. The assembly of claim 1 further comprising a DIC-compatible mounting structure electrically coupled to said control fixture and wherein said DIC is configured for repeatable installation into and removal from said DIC-compatible mounting structure.

3. The assembly of claim 1 wherein said DIC includes a DIC processor coupled to a DIC memory, said DIC processor executing a second set of program instructions accessed from said DIC memory to implement said wireless control architecture.

4. The assembly of claim 2 wherein said DIC includes a DIC processor coupled to a DIC memory, said DIC processor executing a second set of program instructions accessed from said DIC memory to implement said wireless control architecture.

5. The assembly of claim 1 further comprising:
a filtering module, electrically communicated to said DIC and to said control fixture, said filtering module responsive to a filtering control signal and configured to receive the set of digital control inputs from said DIC and provide an output set of digital control inputs to said control fixture, said filtering control signal implementing a filter enable mode and a filter disable mode, said filtering module producing said output set of digital control inputs derived from said set of digital control inputs wherein said output set of control signals includes the set of digital control inputs when said filter signal implements said filter disable mode, and wherein said output set of digital control inputs includes a subset of said set of digital control inputs with said subset less than all said set of control inputs;
wherein said control fixture is configured to respond to said output set of digital control inputs when producing said set of digital control signals.

6. The assembly of claim 2 further comprising:
a filtering module, electrically communicated to said DIC and to said control fixture, said filtering module responsive to a filtering control signal and configured to receive the set of digital control inputs from said DIC and provide an output set of digital control inputs to said control fixture, said filtering control signal implementing a filter enable mode and a filter disable mode, said filtering module producing said output set of digital control inputs derived from said set of digital control inputs wherein said output set of control signals includes the set of digital control inputs when said filter signal implements said filter disable mode, and wherein said output set of digital control inputs includes a subset of said set of digital control inputs with said subset less than all said set of control inputs;
wherein said control fixture is configured to respond to said output set of digital control inputs when producing said set of digital control signals.

7. The assembly of claim 4 further comprising:
a filtering module, electrically communicated to said DIC and to said control fixture, said filtering module responsive to a filtering control signal and configured to receive the set of digital control inputs from said DIC and provide an output set of digital control inputs to said control fixture, said filtering control signal implementing a filter enable mode and a filter disable mode, said filtering module producing said output set of digital control inputs derived from said set of digital control inputs wherein said output set of control signals includes the set of digital control inputs when said filter signal implements said filter disable mode, and wherein said output set of digital control inputs includes a subset of said set of digital control inputs with said subset less than all said set of control inputs;
wherein said control fixture is configured to respond to said output set of digital control inputs when producing said set of digital control signals.

8. The assembly of claim 5 wherein said DIC includes said filtering module.

9. The assembly of claim 1 wherein said wireless control architecture includes an interference reduction auto frequency jumping protocol.

10. A method for a digital wireless control of a slave device from a master controller, the master controller communicating wirelessly a set of digital wireless control signals and the slave device including a control fixture including a fixture processor and a fixture memory, the control fixture implementing a control architecture that produces a set of digital control signals compliant with the control architecture derived from a set of digital control inputs, the fixture processor executing a first set of program instructions accessed from the fixture memory to implement the control architecture, the method comprising the steps of:
(a) communicating wirelessly the set of digital wireless control signals to a first discrete integrated circuit (DIC), said first DIC communicated electrically to the fixture processor and configured to implement a first wireless control architecture responsive to the set of digital wireless control signals; and
(b) producing the set of digital control inputs for the control fixture derived from the digital wireless control signals, said first wireless control architecture different from the control architecture.

11. The method of claim 10 wherein the control fixture includes a DIC-compatible mounting structure communicated electrically to the fixture processor and wherein said first DIC is repeatably mountable into and removeable from said DIC-compatible mounting structure, further comprising:
(c) removing said first DIC from said DIC-compatible mounting structure; and thereafter
(d) installing a second DIC into said DIC-compatible mounting structure, said second DIC configured to implement a second wireless control architecture responsive to the set of digital wireless control signals, said second wireless control architecture different from said first wireless control architecture; and thereafter
(e) producing the set of digital control inputs for the control fixture derived from the digital wireless control signals using said second DIC, said second wireless control architecture different from the control architecture.

12. The method of claim 10 further comprising a filtering module communicated electrically to said first DIC and to the fixture processor, said filtering module responsive to a filter control signal to implement a filter enable mode and a filter disable mode wherein said communicating step (a) includes providing an output set of digital control inputs to the fixture processor, wherein said output set of digital control inputs includes all said digital control inputs when said filtering module includes said filter disable mode and wherein said output set of digital control inputs includes less than all said digital control inputs when said filtering module includes said filter disable mode;
wherein the control fixture is configured to produce the set of digital control signals compliant with the control architecture responsive to said output set of digital control inputs in both said filter enable mode and said filter disable mode.
